(19) United States
(12) Patent Application Publication
(10) Pub. No.: US 2024/0103438 A1
(43) Pub. Date: Mar. 28, 2024

(54) METHOD AND SYSTEM THEREOF FOR PRODUCING DIGITAL HOLOGRAPHIC SCREEN BASED ON MULTI-HOGEL PRINTING

(71) Applicant: HOLOLAB CO., LTD., lksan-si (KR)

(72) Inventors: Dong Hak SHIN, Busan (KR); Yong Seok OH, Busan (KR); Jae Hong KIM, Busan (KR); Jong sung JUNG, Jeonju-si (KR); Jae Woo PARK, lksan-si (KR); Jun Yong CHOI, Busan (KR)

(21) Appl. No.: 18/012,201

(22) PCT Filed: Nov. 11, 2021
(86) PCT No.: PCT/KR2021/016445

§ 371 Date: Dec. 21, 2022

(30) Foreign Application Priority Data
Jul. 23, 2021 (KR) 10-2021-0097301

(51) Int. Cl. G03H 1/04; G03H 1/22

(52) U.S. Cl. CPC G03H 1/0443; G03H 1/2249; G03H 2001/2271; G03H 2210/44; G03H 2222/12; G03H 2223/24

(57) ABSTRACT

A method and a system thereof for producing a digital holographic screen based on multi-hogel printing are proposed. The system includes a light source unit including lasers, a dichroic mirror for RGB three color matching, mirrors, a beam splitter, and an optical shutter, an object beam unit including a spatial filter, a lens, and a mirror, a reference beam unit including a spatial filter, a lens, and a mirror, a diffuser fixing unit including a diffuser holder and a diffuser positioned between the object beam unit and a recording material and configured to scatter and diffuse the object beam, a photomask movement unit including a photomask holder, an XY-translation stage, and a photomask positioned between the reference beam unit and the recording medium and on which a grid-shaped on/off binary pattern is printed, and a controller configured to control the optical shutter and the XY-translation stage.

### TECHNICAL FIELD

The present disclosure relates to a method and a system thereof for producing a digital holographic screen and, more particularly, to a method and a system thereof for producing a digital holographic screen, wherein, in producing the digital holographic screen composed of hogels, one hogel is configured with an RGB sub-pixel structure by using on/off binary pattern photomask, high-speed printing in multi-hogel (i.e., a hogel array or hogel block) units is enabled on the basis of a multi-hogel printing technology capable of printing a plurality of hogels at once, operation is sufficient even with a low-end shutter rather than a high-speed shutter (i.e., AOM, etc.), no Spatial Light Modulator (SLM) is used, an optical configuration of the system is simplified, a system production cost is lowered, a structure of sub-pixels constituting each hogel may be changed in various ways, and the system is suitable for large-area holographic screen production.

### BACKGROUND ART

FIG. 1 is an optical configuration diagram of a digital hologram production system according to the related art.

A laser light source includes beams divided into two beams (i.e., a reference beam and an object beam). In the case of the object beam, while passing through a Spatial Light Modulator (SLM), the object beam includes digital image information and is incident on a recording medium.

The reference beam is incident on the recording medium in a direction opposite to that of the object beam.

Accordingly, when the object beam and the reference beam are incident on the recording medium at the same time, a hologram similar to one dot, that is, a hologram pixel (Hogel), which is corresponding to one dot (i.e., a pixel) of a display device, is recorded.

After one hogel is recorded, the entire hogel is printed on the recording medium as a XY translation stage equipped with the recording medium is moved.

As an example of a conventional patented technology, Korean Patent No. 10-2067762 discloses a method of recording a hologram, the method recording a pattern of interference between a reference beam and signal beams each modulated according to information of a plurality of hologram pixels on a hologram recording medium, and including a multiplexing recording step of recording hogels so that at least some of the hogels adjacent to each other overlap each other, wherein the multiplexing recording step includes: determining a multiplexing factor, M (M>1);
a first hogel recording step of recording a pattern of interference between a reference beam and a signal beam modulated according to first hologram pixel information; and
a second hogel recording step of recording a pattern of interference between a reference beam and a signal beam modulated according to second hologram pixel information,
and when a time during which the hologram recording medium is exposed to light in order to record one hogel is denoted by t in a case of the multiplexing factor is 1, a time during which the hologram recording medium is exposed to light is t/M in each of the first hogel recording step and the second hogel recording step.

In addition, a method for producing a hogel is disclosed in Korean Patent No. 10-2101896.

However, in the case of a conventional digital holographic printing system, hogels are sequentially recorded, and when a recording process of one hogel is finished, a recording medium is moved to a position of the next hogel.

In this case, the generating of one hogel involves moving a XY stage once and opening and closing an optical shutter once.

As such, in the case of the conventional method of sequentially recording each single hogel, numerous hogels should be recorded in order to complete one hologram.

For example, when hogels are recorded in a form of 100×100 (width×height) hogels, 10,000 hogels are required to create one hologram, and 250,000 hogels should be recorded in a form of 500×500 hogels.

Accordingly, a very long time is required to complete one hologram, it is very likely that a printing system, a recording medium, or the like will be affected by external vibration or stray light during the long-term printing, and high stability for long-term operation and reliability against malfunction are required in terms of printing system performance.

In addition, a conventional digital hologram production system requires an expensive high-speed shutter (i.e., AOM, etc.) or a high-resolution SLM, and thus the optical configuration of the system is complicated and the system production cost is inevitably high.

In addition, in the conventional system, it is difficult to accurately imprint a geometric hogel shape due to limitations and distortion of optical elements and/or parts, and a method of correcting the hogel shape by modifying a hogel image displayed on the SLM is selected as an image processing method.

### DISCLOSURE

### Technical Problem

An objective of the present disclosure is to provide a method and a system thereof for producing a digital holographic screen, wherein, in producing the digital holographic screen composed of hogels, one hogel is configured in an RGB sub-pixel structure by using on/off binary pattern photomask, high-speed printing in multi-hogel (i.e., a hogel array or hogel block) units is enabled on the basis of a multi-hogel printing technology capable of printing a plurality of hogels at once, and operation is sufficient even with a low-end shutter rather than a high-speed shutter (i.e., AOM, and the like).

Furthermore, in producing the digital holographic screen composed of the hogels, no Spatial Light Modulator (SLM) is used, an optical configuration of the system is simplified, a system production cost is lowered, a structure of sub-pixels constituting each hogel may be changed in various ways, and the system is suitable for large-area holographic screen production.

The present specification is not limited to the problems mentioned above, and other problems not mentioned will be clearly understood by those skilled in the art from the following description.

### Technical Solution

The present disclosure relates to a system of producing a digital holographic screen based on multi-hogel printing, and the system is configured to include: a light source unit comprising lasers, a dichroic mirror for RGB three color matching, mirrors, a beam splitter, and an optical shutter;
an object beam unit configured to convert one beam of two beams, emitting from the light source unit, into an object beam or a signal beam, and comprise a spatial filter, a lens, and a mirror;
a reference beam unit configured to convert the other beam of the two beams, emitting from the light source unit, into a reference beam, and comprise a spatial filter, a lens, and a mirror;
a diffuser fixing unit comprising a diffuser holder and a diffuser positioned between the object beam unit and a recording material and configured to scatter and diffuse the object beam;
a photomask movement unit comprising a photomask holder, an XY-translation stage, and a photomask positioned between the reference beam unit and the recording medium and on which a grid-shaped on/off binary pattern is printed; and
a controller configured to control the optical shutter and the XY-translation stage.

Accordingly, the system is configured.

In addition, the present disclosure relates to a method of producing a digital holographic screen based on multi-hogel printing, and in producing the digital holographic screen composed of hogels, the method includes constructing one hogel having an RGB sub-pixel structure by using an on/off binary pattern photomask, wherein high-speed printing in multi-hogel units is enabled on the basis of a multi-hogel printing technology that enables printing of a plurality of hogels at once. In addition, the present disclosure relates to a method for producing a digital holographic screen based on multi-hogel printing, and is characterized in that, in producing the digital holographic screen composed of the hogels, one hogel is configured in an RGB sub-pixel structure by using on/off binary pattern photomask, so that high-speed printing in multi-hogel units is enabled on the basis of a multi-hogel printing technology capable of printing a plurality of hogels at once.

### Advantageous Effects

The method and the system thereof for producing the digital holographic screen based on the multi-hogel printing have remarkable effects that one hogel is configured in the RGB sub-pixel structure by using the on/off binary pattern photomask, the high-speed printing in the multi-hogel (i.e., the hogel array or hogel block) units is enabled on the basis of the multi-hogel printing technology capable of printing the plurality of hogels at once, the operation is sufficient even with a low-end shutter rather than a high-speed shutter (AOM, etc.), no Spatial Light Modulator (SLM) is used, the optical configuration of the system is simplified, the system production cost is lowered, the structure of sub-pixels constituting each hogel may be changed in various ways, and the system is suitable for the large-area holographic screen production.

### DESCRIPTION OF DRAWINGS

FIG. 1 is an optical configuration diagram of a conventional digital hologram production system.

FIG. 2 is a block diagram of a system according to the present disclosure.

FIG. 3 is a fundamental optical configuration diagram of the system according to the present disclosure.

FIG. 4 is a fundamental mask pattern in units of pixels applied to a method according to the present disclosure.

FIG. 5 is a mask pattern in a stripe-shaped sub-pixel structure applied to the method according to the present disclosure.

FIG. 6 is a derived mask pattern of the stripe-shaped sub-pixel structure applied to the present method.

FIG. 7 is an optical configuration diagram of the system using the mask pattern of FIG. 4 according to the present disclosure.

FIG. 8 is an optical configuration diagram of the system using the mask pattern of FIG. 5 or 6 according to the present disclosure.

FIG. 9 is an expected result of the system according to the present disclosure. FIG. 9(a) illustrates a result of applying the mask pattern of FIG. 4, FIG. 9(b) illustrates a result of applying the mask pattern of FIG. 5, and FIG. 9(c) illustrates a result of applying the mask pattern of FIG. 6.

FIG. 10 is an optical configuration diagram of the system having a 1-beam structure using the mask pattern of FIG. 4 according to the present disclosure.

FIG. 11 is an optical configuration diagram of the system having a 1-beam structure using the mask pattern of FIG. 5 or 6 according to the present disclosure.

FIG. 12 is the optical configuration diagram of the system having the 1-beam structure using the mask pattern of FIG. 5 or 6 according to the present disclosure.

FIG. 13 is a 3D design view of the system having the two-beam structure according to the present disclosure.

FIG. 14 is a 3D design view of the system having the 1-beam structure according to the present disclosure.

FIG. 15 is a photograph of a preliminary test result of producing a screen with the system having the 2-beam structure according to the present disclosure. FIG. 15(a) illustrates a result of applying a photomask of the pattern of FIG. 4, and FIG. 15(b) illustrates a result of applying a photomask of pattern of FIG. 5.

FIG. 16 is a photograph of a preliminary test result of producing a screen with the system having the 1-beam structure according to the present disclosure. FIG. 16(a) illustrates a result of applying the photomask of the pattern of FIG. 4, and FIG. 16(b) illustrates a result of applying the photomask of the pattern of FIG. 5.

<Description of the Reference Numerals in the Drawings>

| | |
|---|---|
| 1: laser | 2: shutter |
| 3: beam splitter | 4: photomask |
| 5: lens | 6: mirror |
| 7: translation stage | 8: diffuser |
| 9: photosensitive material | 10: spatial filter |

### BEST MODE

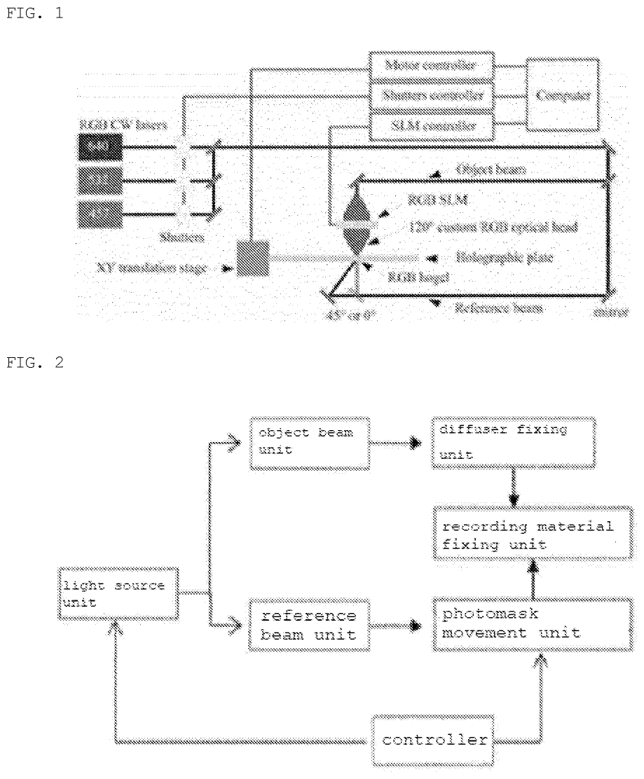

FIG. 2 is a block diagram illustrating a system for producing a digital holographic screen based on multi-hogel printing according to the present disclosure.

According to the present disclosure, the system for producing the digital holographic screen based on the multi-hogel printing is configured to include:
a light source unit including lasers having excellent coherence, a dichroic mirror for RGB three color matching, mirrors, a beam splitter, an optical shutter, and the like;
an object beam unit configured to convert one of two beams, emitting from the light source unit, into an object beam or a signal beam, and include a spatial filter, a lens, a mirror, and the like;
a reference beam unit configured to convert the other beam of the two beams, emitting from the light source unit, into a reference beam, and include a spatial filter, a lens, a mirror, and the like;
a diffuser fixing unit including a diffuser holder and a diffuser positioned between the object beam unit and a recording material and configured to scatter and diffuse the object beam;
a photomask movement unit including a photomask holder, an XY-translation stage, and a photomask positioned between the reference beam unit and the recording medium and on which a grid-shaped on/off binary pattern is printed; and
a controller configured to control the optical shutter and the XY-translation stage.

Accordingly, the system is configured.

FIG. 3 illustrates a fundamental optical configuration diagram of the system according to the present disclosure.

The main characteristics of the optical system of the present disclosure are that the photomask is mounted on a translation stage so that linear movement is enabled, and that the photomask and the diffuser are respectively positioned in front and behind a recording medium so as to be adjacent to each other and.

In general, a photomask is used in a process of printing a semiconductor integrated circuit and an LCD pattern by using a chromium thin film (transmittance of 0.1%) applied on an upper layer of a transparent quartz substrate in the existing semiconductor process.

The role of the photomask used in the present disclosure is to spatially mask a reference beam.

The mask pattern of the photomask is designed so that pixels of the same shape and size are arranged by using each pixel as a fundamental unit, just like that of a display panel, and the mask pattern represents only binary (i.e., On or Off or White or Black) density that may transmit or block light without a separate color filter.

As a reference beam having a large cross-section passes through the photomask, the reference beam is blocked in a blocking (i.e., Off or Black) area, and the reference beam passing through an On or White area meets a signal beam in the recording medium to record a plurality of hogels instead of one hogel. As a result, multi-hogel printing becomes possible, thereby enabling high-speed printing and providing a strong point for large-area holographic screen printing.

In this case, each pixel area of the photomask corresponds to each hogel area of the recording medium on a one-to-one basis, that is, each hogel has the same shape and size as the mask pattern of the photomask.

The shape or structure of each pixel of the photomask is based on a square shape similar to that of a LCD display panel, and pixels having various shapes and structures, such as a rectangular shape, a sub-pixel structure, and a diamond structure, may be applied when required.

In a case where a mask pattern has the sub-pixel structure, additional linear movement of the photomask is required for color multi-hogel printing.

In addition, in a case of using parallel beams as a reference beam and signal beam, which are shown in FIG. 3, a lens, a spatial filter, and the like may be additionally inserted.

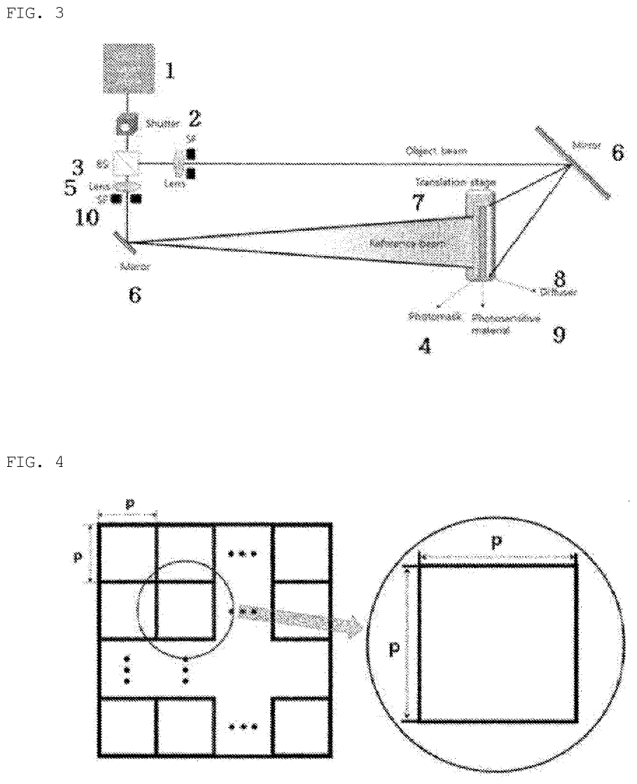

FIGS. 4 to 6 illustrate several examples of photomask patterns applied to the method according to the present disclosure.

Here, for convenience, it is assumed that a line width (i.e., a line thickness) of a pattern is zero, and when an actual mask pattern is produced, it is required to design the mask pattern in consideration of the line width.

FIG. 4 illustrates a fundamental mask pattern in units of pixels. Similar to the pixel structure of a black and white LCD panel, each pixel of the photomask is composed of a single rectangular area.

This pattern is applied when laser light having three wavelengths of R, G, and B is incident simultaneously or is incident sequentially by wavelength, and the three-wavelength laser light is evenly exposed to the entire hogel area of the recording medium, whereby color hogels are created simultaneously.

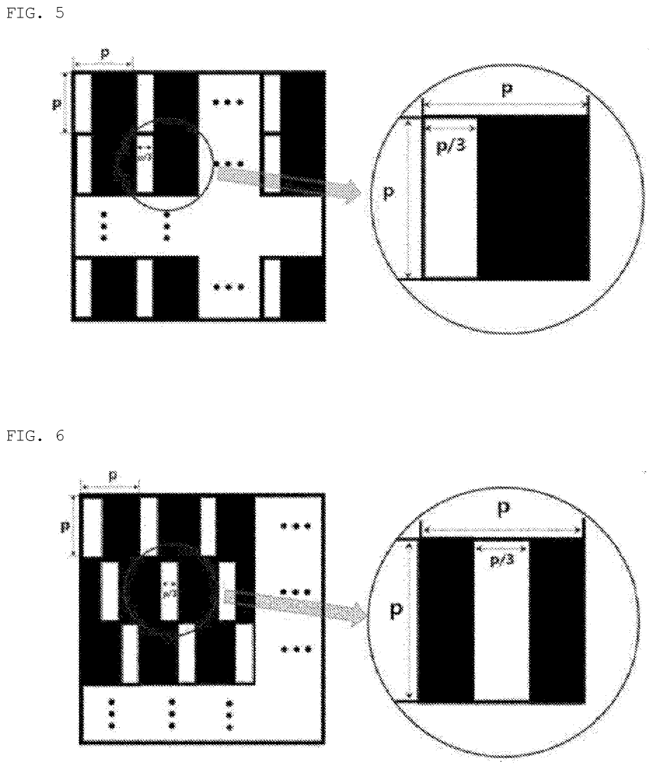

FIG. 5 illustrates a mask pattern in a stripe-shaped sub-pixel structure similar to that of a color LCD display panel.

Characteristics of this mask pattern is that one pixel area is divided into three areas in the horizontal direction, and ⅓ of the areas is configured as a transmission (i.e., On) area and ⅔ of the areas is configured as a blocking (i.e., Off) area.

The period of transmission (On) sub-pixels is the same as that of a pixel pitch, and the overall mask pattern looks like a row of long vertical bars.

In FIG. 5, although a position of a transmission (On) area is placed at a position of the first sub-pixel of each pixel, it may be designed to be placed at a position of the second or third sub-pixel when required.

The purpose of using this pattern is to complete one color hogel by recording three sub-hogels of R, G, and B one by one in one hogel area in order not to be spatially overlapped with each other.

In order to print multi-hogels by applying this pattern, it is required to sequentially expose laser light by color while moving the photomask little by little so that transmission (On) areas of the photomask are matched with positions of corresponding sub-hogels.

More specifically, when laser light of R is first exposed, R sub-hogels of which the period is the pixel pitch are entirely recorded on the recording medium in the same way as that of the mask pattern.

Next, when the photomask is moved by ⅓ of the pixel pitch, transmission (On) areas of the photomask match positions of adjacent G sub-hogels, and then, when laser light of G is exposed, the G sub-hogels are created entirely on the recording medium.

When the same process is repeated for B sub-hogels, one color hogel is completed by the three adjacent sub-hogels of R, G, and B, and at the same time, multi-hogels are created throughout the recording medium.

When a color hologram is recorded on a recording medium by using a conventional holography method, diffraction efficiency of the color hologram is very low compared to that of a monochromatic hologram.

However, when multi-hogels are printed by using the mask pattern of FIG. 5, it is theoretically possible to create sub-hogels with the diffraction efficiency similar to that of the monochromatic hologram because each sub-hogel is created at a spatially independent position. Finally, color multi-hogel printing that has the diffraction efficiency similar to that of the monochromatic hologram as a whole becomes possible.

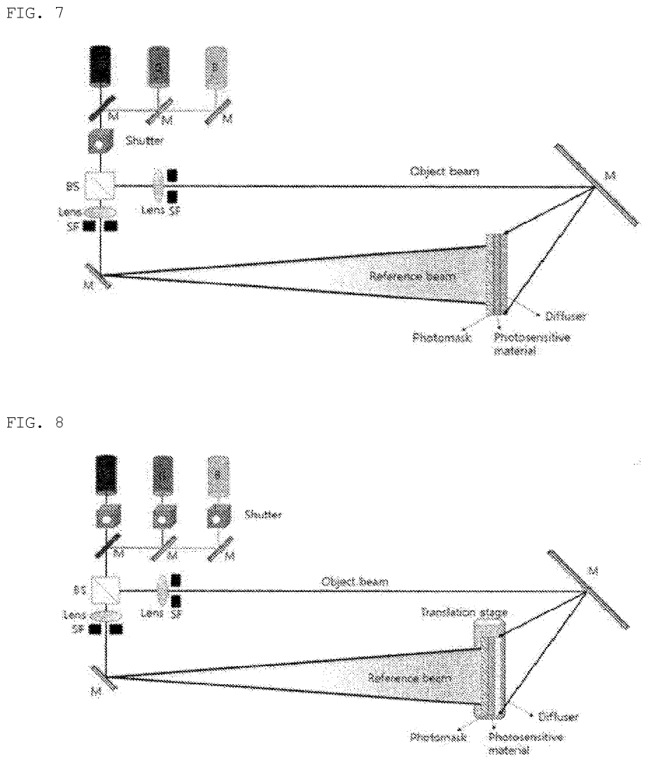

FIG. 6 illustrates a mask pattern in a sub-pixel structure derived from FIG. 5.

Comparing FIGS. 6 and 5 with each other, spatial positions of transmission (On) areas of respective pixels of the mask pattern are the same in FIG. 5, whereas in the case of the mask pattern of FIG. 6, it is designed such that positions of transmission (On) areas are arranged at the first sub-pixel positions of respective pixels in row 1 similar to that of FIG. 5, at the second sub-pixel positions of respective pixels in row 2, and at the third sub-pixel positions of respective pixels in row 3. In subsequent rows, the position arrangement of rows 1 to 3 is repeated.

As in FIG. 5, by using the mask pattern of FIG. 6, multi-hogels may be printed through the proper movement of the photomask and the consequent sequential exposure for each wavelength of laser light.

Describing the sub-hogel distribution in the result of applying the pattern of FIG. 6, each hogel is arranged such that row 1 is arranged in RGB order, row 2 in BRG order, and row 3 in GBR order.

In the first and last hogels of rows 2 and 3, some sub-hogels are left blank, but this may be ignored.

From row 4, the distribution in which row 1 to row 3 are repeated is visible.

In the result of applying the mask pattern of FIG. 5, since sub-hogels of the same color are vertically distributed in a hologram, there is a possibility that a phenomenon in which long vertical lines are faintly seen may occur when the hologram is illuminated with a reproduction beam. However, in the result of applying the mask pattern of FIG. 6, in the hologram, such a phenomenon structurally disappears due to geometric distribution of FIG. 6.

The present disclosure proposes two optical system configurations based on the number of recording beams.

One is a production system having a 2-beam recording structure using two beams (i.e., a reference beam and an object beam), and the other is a production system having a 1-beam recording structure using only one beam (i.e., a reference beam).

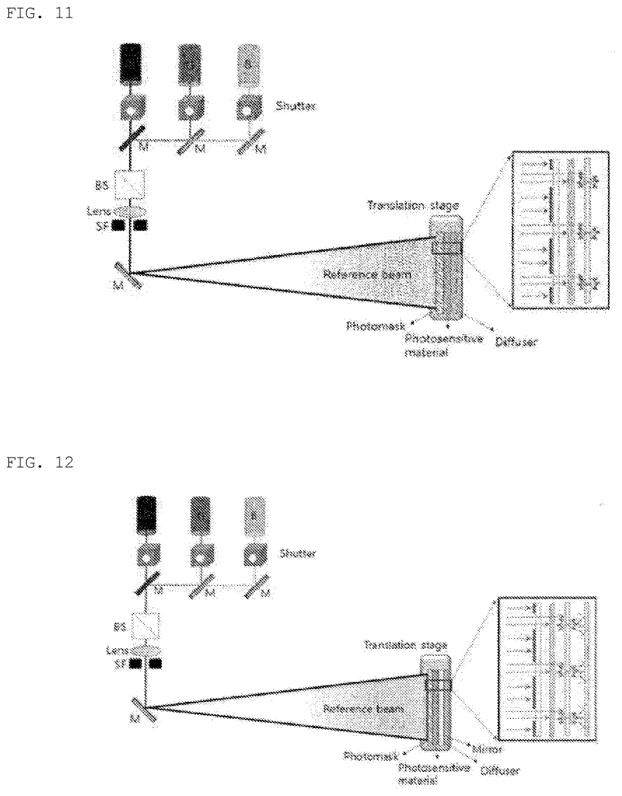

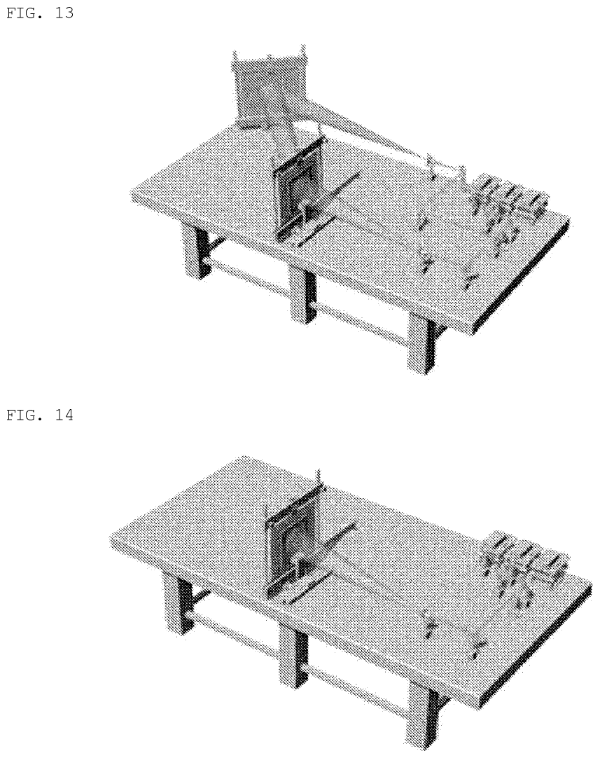

FIGS. 7 and 8 are views describing the 2-beam recording structure, and FIGS. 10 and 11 are views describing the 1-beam recording structure.

In the production system of FIG. 7, the same mask pattern of the photomask as that of FIG. 4 is used, and a light source unit is composed of three laser beams of R, G, and B, one optical shutter, and the like, and the photomask does not move.

In the configuration of FIG. 7, the reference beam and the signal beam, which have three mixed colors of R, G, and B, are exposed to the recording medium to print multi-hogels. When each hogel is illuminated with a white reproduction beam, each hogel is viewed as a white color properly mixed with RGB.

A strong point of the configuration of FIG. 7 is that the require printing time is very short compared with that of single hogel-based printing because a holographic screen of the same size as a photomask is created even when a color beam is exposed only once.

In contrast, the diffraction efficiency of each hogel is lower than that of the monochromatic hologram because the entire hogel is illuminated with three kinds of color beams.

FIG. 8 is an optical configuration diagram of a system adopting the photomask pattern of FIG. 5 or 6 according to the present disclosure.

In FIG. 8, a difference between FIG. 8 and FIG. 7 is that optical shutters are installed one by one in front of the respective lasers of R, G, and B, and the photomask are required to be moved.

As described in FIG. 5, one holographic screen may be printed by sequentially exposing the light sources of R, G, and B and moving the photomask twice.

In other words, multi-hogel printing is completed when the photomask is illuminated with a laser light of a corresponding color while being moved by ⅓ of the pixel pitch.

A strong point of the printing system shown in FIG. 8 is that, as described in FIG. 5, the sub-hogels constituting each hogel inside a holographic screen are created at independent positions, so even though the holographic screen is printed in color, the diffraction efficiency of the holographic screen is as high as that of the monochromatic hologram.

In addition, since one screen is completed by exposing the light source three times and moving the photomask twice, it is also a strong point that significantly fast high-speed printing is enabled compared with that of single hogel-based printing.

FIGS. 7 and 8 have the same structure except for the number of optical shutters and the presence of the translation stage.

Accordingly, the mask pattern of FIG. 4 may also be used in the optical configuration of FIG. 8. In this case, when three optical shutters are opened and closed simultaneously and the operation of the translation stage is excluded, a result similar to that obtained in the configuration of FIG. 7 may be obtained.

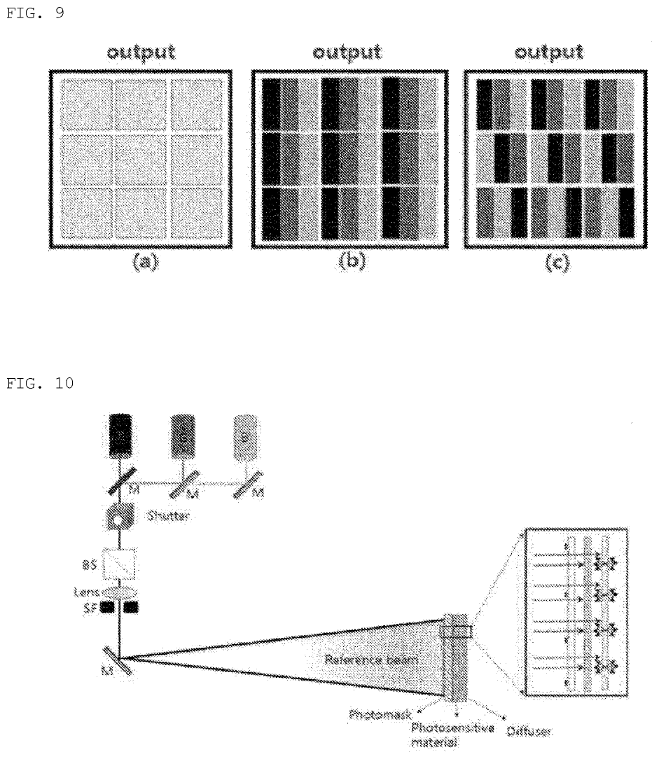

FIG. 9 illustrates expected results in a case where the mask patterns shown in FIGS. 4 to 6 are applied to the system according to the present disclosure.

FIGS. 9(a), 9(b), and 9(c) are respective views illustrating pictures of the expected results when the respective mask patterns of FIGS. 4, 5, and 6 are used.

FIGS. 10 to 12 illustrate respective optical configurations of the system having the 1-beam recording structure according to the present disclosure.

The reason why holographic screen printing is possible with only one light beam is as follows.

When a light beam incidents into a diffuser, the light is scattered by the scattering particles inside the diffuser. In this case, not only the light diffused (i.e., scattered) in the transmission direction but also the light diffused (i.e., scattered) in the reflected direction are generated.

In this way, the diffused (i.e., scattered) beam reflected by the diffuser may sufficiently perform a role of an object beam (i.e., a diffused laser beam that is transmitted) incident on the recording medium in the 2-beam structure.

Therefore, these two beams, i.e., the reference beam incident on the recording medium after passing through the photomask and the object beam generated as the beam passing through the recording medium is reflected and diffused by the diffuser, meet in the recording medium, thereby creating hogels.

Compared with the 2-beam structure, the strong points of the 1-beam recording structure as shown in FIGS. 10 to 12 are as follows.

First, light efficiency (or energy efficiency) is increased because light source output is not divided into two (the light efficiency is estimated to be improved by about twice).

Second, the intensity of the reference beam and the object beam is high, so the exposure time is shortened (the exposure time is estimated to be decreased by about ½).

Third, only the reference beam is used in the structure, so the optical configuration becomes simpler.

Fourth, a space required for constructing an optical system is reduced.

Fifth, the cost required for constructing the optical system may be reduced.

FIG. 10 illustrates an optical configuration applying the mask pattern of FIG. 4 and the 1-beam structure, and operation details are the same as the mentioned description in FIG. 7.

FIG. 11 illustrates an optical configuration applying the mask pattern of FIG. 5 or 6 and the 1-beam structure, and operation details are the same as the mentioned description in FIG. 8.

FIG. 12 is a configuration in which a mirror is added to the left side of the diffuser in FIG. 11, and since the amount (or intensity) of light acting as a signal beam may be increased due to the mirror, more effective recording is enabled than that of FIG. 11.

FIGS. 10 to 12 have the same configuration except for the number of optical shutters and the presence of the translation stages.

Accordingly, the mask pattern of FIG. 4 may also be used in the optical configuration of FIG. 11 or FIG. 12. In this case, when three optical shutters are opened and closed simultaneously and the operation of the translation stage is excluded, the result similar to that obtained in the configuration of FIG. 10 may be obtained.

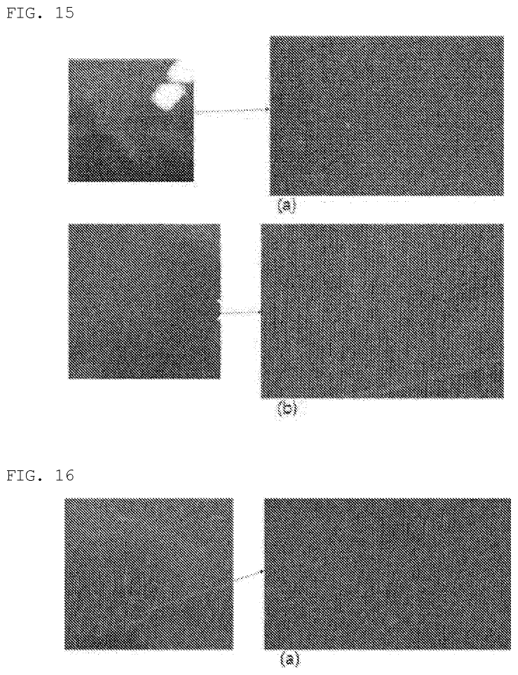

FIGS. 15 and 16 illustrate the results of preliminary experiments for confirming the possibility of producing the holographic screens by the system according to the present disclosure.

The light source used in these experiments were a green laser, and the experiment were performed by fixing the photomask without operating the translation stage.

FIG. 15 is an experimental result of the system having the 2-beam structure according to the present disclosure.

FIG. 15(a) is an experimental result applying the content of FIGS. 4 and 7, and it may be confirmed that each hogel is well recorded.

FIG. 15(b) is an experimental result applying the content of FIGS. 5 and 8, and it may be confirmed that each G sub-hogel is well recorded and the method of the present disclosure is effective.

1. A system of producing a digital holographic screen based on multi-hogel printing, the system comprising:
a light source unit comprising lasers (1), a dichroic mirror (6) for RGB three color matching, mirrors (6), a beam splitter (3), and an optical shutter (2);
an object beam unit configured to convert one beam of two beams, emitting from the light source unit, into an object beam or a signal beam, and comprise a spatial filter (10), a lens (5), and a mirror (6);
a reference beam unit configured to convert the other beam of the two beams, emitting from the light source unit, into a reference beam, and comprise a spatial filter (10), a lens (5), and a mirror (6);
a diffuser fixing unit comprising a diffuser holder and a diffuser (8) positioned between the object beam unit and a recording material and configured to scatter and diffuse the object beam;
a photomask movement unit comprising a photomask holder, an XY-translation stage (7), and a photomask (4) positioned between the reference beam unit and the recording medium and on which a grid-shaped on/off binary pattern is printed; and
a controller configured to control the optical shutter (2) and the XY-translation stage (7).

2. A method of producing a digital holographic screen based on multi-hogel printing, the method producing the digital holographic screen composed of hogels and comprising:
constructing one hogel having an RGB sub-pixel structure by using an on/off binary pattern photomask (4),
wherein high-speed printing in multi-hogel units is enabled on the basis of a multi-hogel printing technology that enables printing of a plurality of hogels at once.

3. The method of claim 2, wherein, in a pattern, one color hogel is completed by recording three sub-hogels of R, G, and B one by one in respective hogel areas so as not to be spatially overlapped with each other.
